(19) United States
(12) Patent Application Publication
(10) Pub. No.: US 2013/0153755 A1
(43) Pub. Date: Jun. 20, 2013

(54) Optical Proximity Sensing

(71) Applicants: Kalle Eino Olavi Pikkujamsa, Oulu (FI); Ralf Wieser, Beimerstetten (DE)

(72) Inventors: Kalle Eino Olavi Pikkujamsa, Oulu (FI); Ralf Wieser, Beimerstetten (DE)

(73) Assignee: Nokia Corporation, Espoo (FI)

(21) Appl. No.: 13/813,553

(22) PCT Filed: Aug. 3, 2010
(86) PCT No.: PCT/IB2010/053521

§ 371 Date: Feb. 26, 2013

(51) Int. Cl. G01V 8/12; G01V 8/20

(52) U.S. Cl. CPC G01V 8/12; G01V 8/20
USPC 250/221

(57) ABSTRACT

An optical proximity sensor module including a housing; an integrated light emitter configured to emit light; a diffractive optical element positioned in front of the light emitter and configured to direct light emitted by the light emitter towards a target volume in front of the diffractive optical element; and an integrated light detector configured to detect light reflected from a proximal object at the target volume.

### TECHNOLOGICAL FIELD

Embodiments of the present invention relate to optical proximity sensing. In particular, some embodiments of the present invention relate to an optical proximity sensor module.

### BACKGROUND

An optical proximity sensor typically comprises a light emitter and a light detector. Light is emitted by the light emitter and reflected by a proximal object onto the light detector. The increase in light detected by the light detector indicates the presence of a proximal object.

It is desirable to modularize optical proximity sensors so that they can be easily integrated into larger apparatus.

It may be necessary to locate an optical proximity sensor module at a specific location within an apparatus to achieve satisfactory performance. This can place a serious constraint on the design of the relationship of internal components of the apparatus.

It would be desirable to provide an optical proximity sensor module that can be configured to operate in different locations.

### BRIEF SUMMARY

According to various, but not necessarily all, embodiments of the invention there is provided an optical proximity sensor module comprising:

a housing; an integrated light emitter configured to emit light;
a diffractive optical element positioned in front of the light emitter and
configured to direct light emitted by the light emitter towards a target volume in front of the diffractive optical element; and an integrated light detector configured to detect light reflected from a proximal object at the target volume.

According to various, but not necessarily all, embodiments of the invention there is provided an apparatus comprising an optical proximity sensor module as claimed in any preceding claim; an apparatus housing comprising an aperture; wherein the target volume in front of the diffractive optical element is located in front of the aperture at an exterior of the housing.

According to various, but not necessarily all, embodiments of the invention there is provided an optical proximity sensor module comprising: a housing; an integrated light emitter configured to emit light; a fixing configured to secure a diffractive optical element in front of the light emitter and direct light emitted by the light emitter towards a target volume in front of the diffractive optical element; and an integrated light detector configured to detect light reflected from a proximal object at the target volume.

According to various, but not necessarily all, embodiments of the invention there is provided an optical proximity sensor system comprising: a light emitter configured to emit light; a diffractive optical element positioned in front of the light emitter and configured to direct light emitted by the light emitter towards a target volume in front of the diffractive optical element; and a light detector configured to detect light reflected from a proximal object at the target volume.

The optical proximity sensor module can be configured to operate in different locations. For example, the diffractive optical element can be configured to provide desired beam forming and/or beam directing.

The diffractive optical element can also be configured to provide controlled cross-talk between the light emitter and the light detector. This can enable the proper function of the optical proximity module to be tested in situ.

### BRIEF DESCRIPTION

For a better understanding of various examples of embodiments of the present invention reference will now be made by way of example only to the accompanying drawings in which:

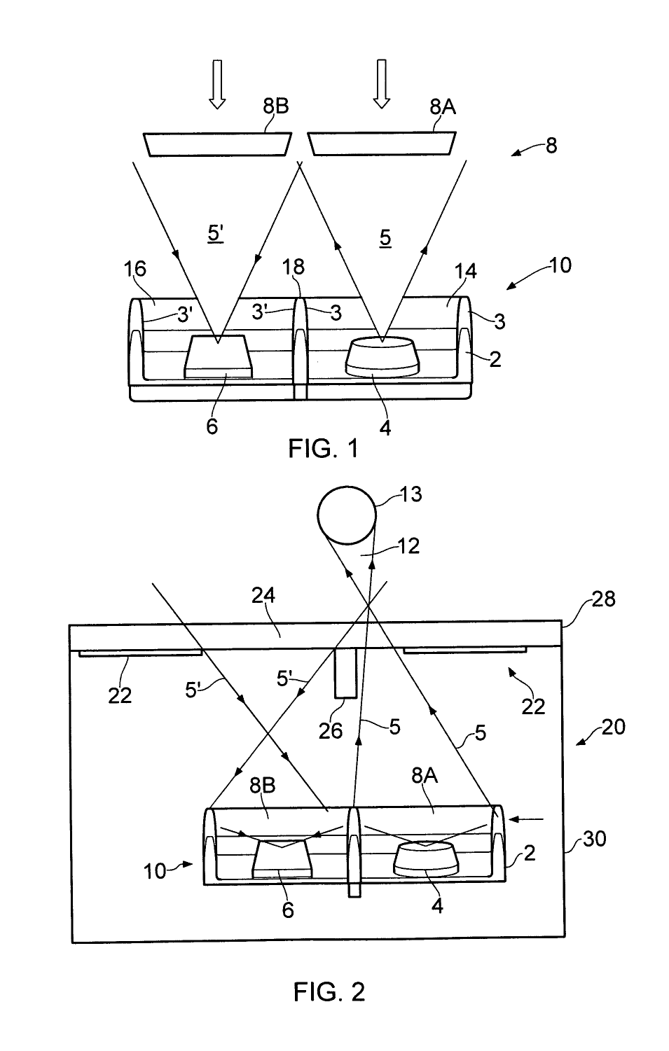

FIG. 1 schematically illustrates an optical proximity sensor module and diffractive optical elements;

FIG. 2 schematically illustrates an optical proximity sensor module, with diffractive optical elements, within an apparatus;

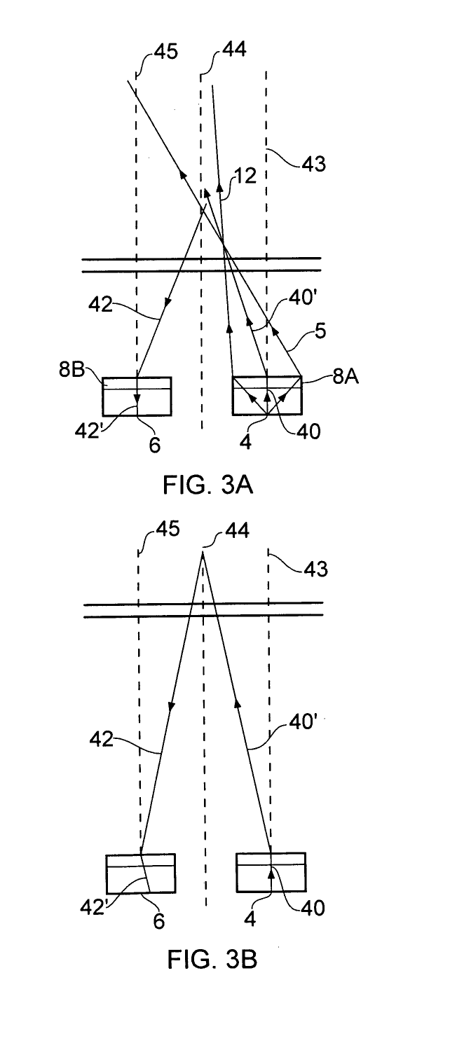

FIGS. 3A and 3B schematically illustrate how different first diffractive optical elements operate differently to shape (concentrate) and redirect the light emitted by the light emitter;

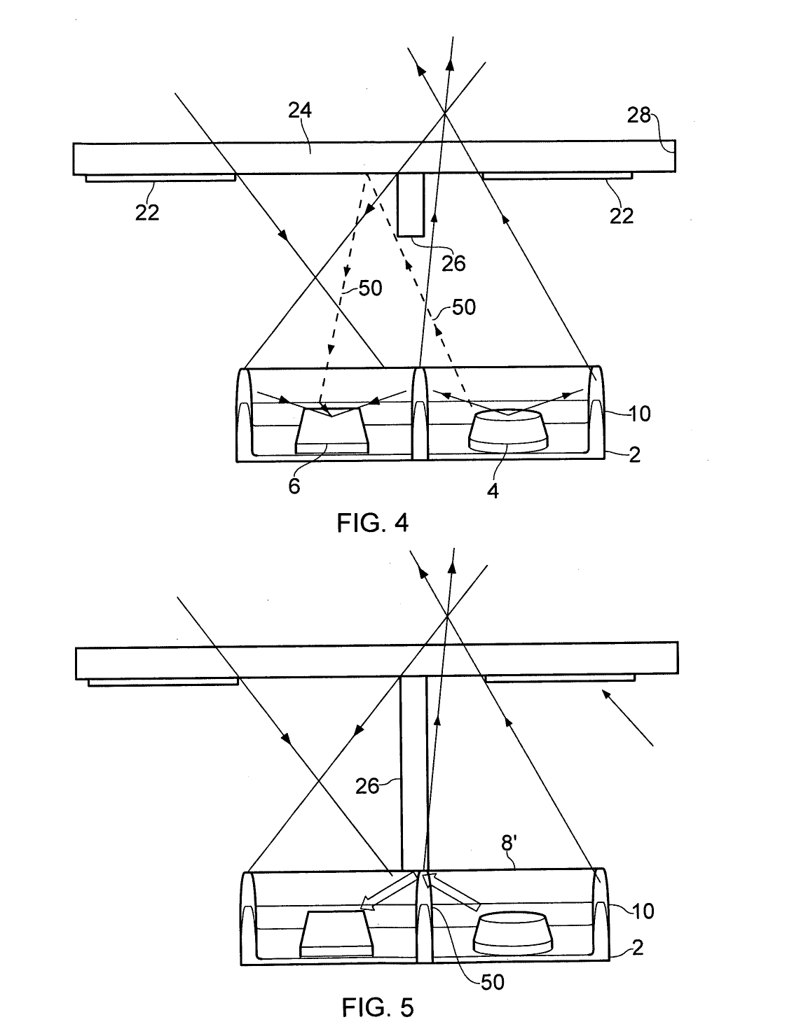

FIGS. 4 and 5 schematically illustrate examples of the optical proximity sensor module that have been designed to create controlled cross-talk between the light emitter and the light detector;

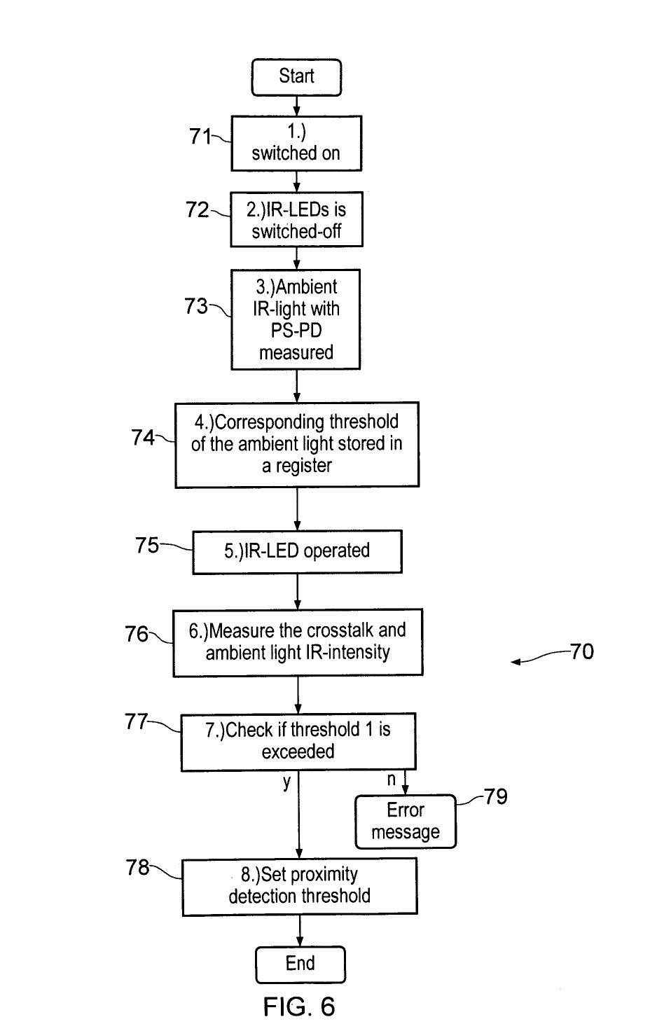

FIG. 6 schematically illustrates a method in which a self-test is performed automatically when the optical proximity sensor module is first powered on;

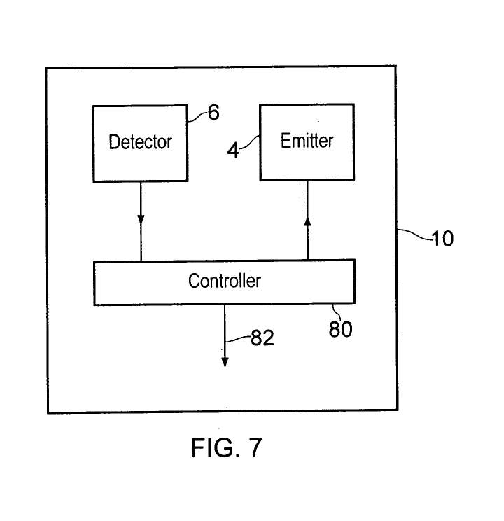

FIG. 7 schematically illustrates at least some of the functional electronic components of the optical proximity sensor module.

### DETAILED DESCRIPTION

Some of the Figures schematically illustrate an optical proximity sensor module 10 comprising: a housing 2 an integrated light emitter 4 configured to emit light 5; a diffractive optical element 8A positioned in front of the light emitter 4 and configured to direct light 5 emitted by the light emitter 4 towards a target volume 12 in front of the diffractive optical element 8A; and an integrated light detector 6 configured to detect light 5′ reflected from a proximal object 13 at the target volume 12.

FIG. 1 schematically illustrates an optical proximity sensor module 10 comprising: a housing 2; a light emitter 4 configured to emit light 5; and a light detector 6 configured to detect light 5′. The light emitter 4 and the light detector 6 are both ‘integrated’ in the sense that they are functionally interconnected to the module 10 such that they may operated to emit light and to detect light, respectively.

In the illustrated example, the light emitter 4 and the light detector 6 lie in substantially the same plane, although this is not always necessary. The housing 2 comprises an optical isolator 18 that improves optical isolation of the light detector 6 from the light emitter 4.

In the illustrated example, the optical isolator 18 is a portion of the housing 2 that separates a cavity 14 comprising the light emitter 4 and a cavity 16 comprising the light detector 6.

The example of the housing 2 illustrated comprises a first fixing 3 configured to secure a first diffractive optical element 8A in front of the light emitter 4. The position and type of diffractive optical element 8A is selected so that the diffractive optical element directs light 5 emitted by the light emitter 4 towards a predetermined target volume 12 (not illustrated in FIG. 1) in front of the diffractive optical element 8A.

The first fixing 3 is configured to enable the attachment of the first diffractive optical element 8A. It may be configured to enable the releasable attachment of the first diffractive optical element 8A so that the module 10 may have different operative configurations using different diffractive optical elements 8A.

The first fixing 3 may be configured to enable the positioning of the first diffractive optical element 8A at a desired distance above the light emitter 4.

The selection of the diffractive optical element 8A and/or the selection of the distance of the diffractive optical element 8A from the light emitter 4 may be used to control the position and size of a target volume 12 in front of the diffractive optical element 8A.

This illustrated example of the housing 2 also comprises a second fixing 3′ configured to secure a second diffractive optical element 8B in front of the light detector 6. The position and type of second diffractive optical element 8B is selected so that the second diffractive optical element 8B directs light 5′ reflected from a proximal object at the target volume 12 towards the light detector 6.

The second fixing 3′ is configured to enable the attachment of the second diffractive optical element 8B. It may be configured to enable the releasable attachment of the second diffractive optical element 8B so that the module 10 may have different operative configurations using different second diffractive optical elements 8B.

The second fixing 3′ may be configured to enable the positioning of the second diffractive optical element 8B at a desired distance above the light detector 6.

The selection of the diffractive optical element 8B and/or the selection of the distance of the diffractive optical element 8B from the light detector 6 may be used so that light 5′ reflected from a proximal object 13 at the target volume 12 is efficiently directed towards the light detector 6.

FIG. 2 schematically illustrates the module 10 in an assembled configuration with the first diffractive optical element 8A and the second diffractive optical element 8B positioned and fixed in situ above the light emitter 4 and the light detector 6, respectively.

The optical proximity sensor module 10 comprises: a housing 2; an integrated light emitter 4 configured to emit light 5; a first diffractive optical element 8A positioned in front of the light emitter 4 and configured to direct light 5 emitted by the light emitter 4 towards a target volume 12 in front of the diffractive optical element 8A; and an integrated light detector 6 configured to detect light 5′ reflected from a proximal object at the target volume 12. It also comprises a second diffractive optical element positioned in front of the light detector 6 and configured to direct light 5′ reflected from a proximal object 13 at the target volume 12 towards the light detector 6.

In this example but not necessarily all examples the first diffractive optical element 8A seals the cavity 14 in the housing 2 comprising the light emitter 4. This sealing reduces or prevents the ingress of dirt and/or moisture to the light emitter 4.

In this example but not necessarily all examples the second diffractive optical element 8B seals the cavity 16 in the housing 2 comprising the light detector 6. This sealing reduces or prevents the ingress of dirt and/or moisture to the light detector 6.

In FIG. 2, the module 10 is part of a larger apparatus 20. The larger apparatus 20 may, for example, be a hand portable device such as a personal music player, a mobile cellular telephone, a wireless communications device etc. The apparatus housing 28 may create a body sized to fit within the palm of a human hand.

The apparatus 20 comprises an apparatus housing 28 having an aperture 24. The aperture 24 may, for example, be a physical aperture or opening in the housing 28 or it may be an optical aperture in the housing 28.

In the illustrated example, the aperture 24 is an optical aperture. A portion of the housing 28 is optically transparent at the wavelength of light used by the light emitter. It may, or may not be optically transparent to visible light. The aperture 24 is defined using optical masking material 22 on an interior surface of the housing 28. The absence of the masking material 22 defines an aperture 24. Alternatively the optical masking material 22 could also be attached on an exterior surface of the housing 28 or in between the housing (e.g. an optical double-layer housing would be also feasible).

In the illustrated example, a single aperture is defined and is used for the emission of light 5 and the reception of reflected light 5′. In other examples, one aperture may be defined for the emission of light 5 and another distinct aperture may be defined for the reception of reflected light 5′.

In the illustrated example, an optical isolator 26 is positioned within the optical aperture 24, between the light emitter 4 and the light detector 6, on the underside of the housing 28. This improves the optical isolation of the light detector 6 from the light emitter 4. In particular it reduces or prevents light 5, which is reflected from the housing 28 reaching the light detector 6.

The target volume 12 in front of the diffractive optical element 8A is located in front of the aperture 24 so that the aperture 24 is between the target volume 12 and the optical proximity sensor module 10.

Canon® has created a multi-layer diffractive optical element from two single-layer diffractive optical elements with opposing concentric circular diffraction gratings. Figs on Canon's website (education/infobank/lenses/multi-layer Diffractive Optical Element) illustrate some examples of diffractive optical elements suitable for use as the first diffractive optical element 8A and/or the second diffractive optical element 8B. These Figures and the accompanying description are incorporated by reference. However, it should be realized that there are many other examples of diffractive optical elements that are not illustrated.

A Diffractive Optical Element typically uses one or more surfaces that have a complex microstructure relief which is carefully controlled to achieve a desired optical function. The microstructure relief may be at a scale similar to the wavelength of the light emitted by the light emitter 4. The microstructure relief typically has two or more surface levels. The microstructure relief modulates incident light waves in a controlled manner which then constructively and destructively interferes to produce a desired optical effect such as beam splitting and/or beam shaping and/or beam directing.

A single layer diffractive optical element 8 may perform a beam shaping function. It may condense the beam towards a point or reduced area.

A multi-layer diffractive optical element 8 may perform a beam shaping function. It may condense the beam towards a point or reduced area. It may have reduced scattering of light compared to the single layer diffractive optical layer which would reduce cross-talk between the light emitter 4 and light detector 6.

In some implementations the diffractive optical element 8 may have a flat surface. A flat top surface may be a preferred solution as it may enable an easy assembly using a nozzle of a production robot. However, in general any surface of the diffractive optical element could be assembled.

FIGS. 3A and 3B schematically illustrate how the first diffractive optical element 8A operates to shape (concentrate) and redirect the light emitted by the light emitter 4.

The cross-sectional area of the emitted light 5 increases as it travels from the light emitter 4 towards the first diffractive optical element 8A. The energy of the light is being spread over a larger and larger area as the light travels from the light emitter to the first diffractive optical element 8A.

The cross-sectional area of the emitted light 5 decreases as it travels away the first diffractive optical element 8A and becomes concentrated in the region of the target volume 12. The energy of the light is being spread over a smaller and smaller area as the light initially travels from the first diffractive optical element 8A towards the target volume 12.

The rate at which the cross-sectional area of the emitted light 5 decreases as it travels away from the first diffractive optical element 8A can be controlled by the design of the first diffractive optical element 8A.

The first diffractive optical element 8A can also re-direct light. The light emitter 4 emits light which is distributed about a mean emission vector 40 and the diffractive optical element is configured to direct the emitted light such that the directed light is distributed about a mean directed vector 40′. The mean directed vector 40′ has an angular deviation from the mean emission vector 40 in a direction towards the light detector 6 so that when it is reflected off an object 13, the reflected light is directed towards the light detector 6.

In some but not necessarily all examples, the target volume 12 may be positioned over a point 44 that is equidistant between a position 43 of the light emitter 4 and a position 45 of the light detector 6.

It may be observed by comparing FIG. 3A and FIG. 3B that by controlling the characteristics of the first diffractive optical element (e.g. its convergent power and rate of re-direction) one can control the location of the target volume 12. This may be useful if the module 10 is to be used in different apparatus 20 where the aperture 24 is at different distances above the light emitter. One can control the target volume such that it is consistently at a desired location above the aperture 24 irrespective of the distance between the aperture 24 and the light emitter 4.

The cross-sectional area of the reflected light 5′ increases as it travels towards the second diffractive optical element 8B. The energy of the light is being spread over a larger and larger area as the light travels towards the second diffractive optical element 8B. The cross-sectional area of the reflected light 5′ decreases as it travels away from the second diffractive optical element 8B and becomes concentrated in the region of the light detector 6. The energy of the light is being spread over a smaller and smaller area as the light initially travels from the second diffractive optical element 8B towards the light detector 6.

The rate at which the cross-sectional area of the reflected light 5′ decreases as it travels away the second diffractive optical element 8B can be controlled by the design of the second diffractive optical element 8B. This can allow the optical proximity sensor module to be of very low profile.

FIGS. 4 and 5 schematically illustrate examples of the module 10 that have been designed to create controlled cross-talk between the light emitter 4 and the light detector 6. Cross-talk between the light emitter 4 and the light detector 6 arises when there is a path between the light emitter 4 and the light detector 6 taken by light emitted by the light emitter 4 that does not involve reflection from an object 13. Normally, one would expect a module 10 to be designed to reduce or eliminate cross-talk as it represents noise on a signal used for proximity detection. However, in these examples the first diffractive optical element 8A has been engineered to provide a controlled amount of cross-talk between the light emitter 4 and the light detector 6 to provide additional self-test functionality for the module 10 as described below with reference to FIGS. 6 and 7.

In FIG. 4, the first diffractive optical element 8A is engineered to produce a low intensity cross-talk beam 50 that is designed to be reflected by the housing 28 back into the light detector 6.

In FIG. 5, the first diffractive optical element 8A and the second diffractive optical element 8B are integral parts of a single common diffractive optical element 8′. The common diffractive optical element 8′ is engineered to produce a low intensity cross-talk beam 50 that is designed to be directed by the common diffractive optical element 8′ towards the light detector 6.

FIG. 7 schematically illustrates at least some of the functional electronic components of the module 10. In this Figure, a controller 80 is configured to control the light emitter 4 to emit light and is configured to receive an input from the light detector 6 when the light detector 6 detects light.

The controller 80 may be configured, when it controls the light emitter 4 to be off, to set a first threshold from an input received from the light detector 6. As the light emitter 4 is off, this input represents an ambient value indicative of the intensity of the ambient light detected by the light detector 6.

The controller 80 may also be configured, when it controls the light emitter 4 to be on during a test mode, to compare an input received from the light detector 6 with the set first threshold. As the light emitter 4 is on, this input represents a value indicative of the intensity of the ambient light detected by the light detector 6 and the intensity of the cross-talk beam 50.

The controller 80 is configured to determine that the optical proximity sensor is not working properly when the comparison determines that the value detected is less than a first threshold based on the detected ambient value plus an expected contribution from the cross-talk beam 50. If the expected contribution from the cross-talk beam is absent (the first threshold is not exceeded) then it is indicative that the light emitter 4 is not functioning correctly.

The controller 80 may also be configured to determine that the optical proximity sensor is suffering from too much cross-talk when the comparison determines that the value detected is greater than a second threshold based on the detected ambient value and a maximum allowable contribution from the cross-talk beam 50. If the expected contribution from the cross-talk beam is too great (the second threshold is exceeded) then it is indicative that the optical proximity sensor module is not operating correctly. The second threshold is greater than the first threshold.

The controller 80 may also be configured to set a proximity detection threshold based on the detected ambient value and an expected minimum contribution from light reflected from an object in the target volume 12. The proximity detection threshold is greater than the first threshold and may be greater than the second threshold (if used).

The controller 80 may continuously or intermittently compare an input received from the light detector 6 against the proximity detection threshold. If the proximity detection threshold is exceeded then an interrupt signal 82 may be generated.

The interrupt signal may be used to control an output device (not illustrated) of the apparatus 20. Thus for example, the apparatus may switch-off a touch sensitive screen when a mobile cellular telephone is raised close to the head during a telephone call. Thus for example, a powerful loudspeaker may be switched-off or attenuated when there is a proximity detection. The interrupt signal 82 is useful for providing other safety features.

FIG. 6 schematically illustrates a method 70 in which a self-test is performed automatically when the module 10 is first powered on.

At block 71, the apparatus 20 is switched on.

At block 72, the light emitter 4 is set to off.

At block 73, the light detector 6 detects ambient light and produces an output value indicative of the intensity of the ambient light.

At block 74, the ambient light value is used to generate a first threshold which is stored in a register memory.

At block 75, the light emitter 4 is set to on.

At block 76, the light detector 6 detects light and produces an output test value indicative of the intensity of the ambient light and the intensity of the cross-talk beam 50.

At block 77, the test value is compared with the first threshold value.

If the first threshold is not exceeded an error interrupt is generated at block 79.

If the first threshold is exceeded the method moves to block 78.

At block 78, the ambient light value is used to generate a proximity detection threshold which is stored in a register memory.

The optical proximity sensor module 10 may also comprise an additional ambient light detector (not illustrated) for controlling a backlight intensity of a display (not illustrated).

The light emitter 4 may emit light at any suitable wavelength. It may for example emit light in the infra-red spectrum only.

Implementation of controller 80 can be in hardware alone (a circuit, a processor . . . ), have certain aspects in software including firmware alone or can be a combination of hardware and software (including firmware).

The controller 80 may be implemented using instructions that enable hardware functionality, for example, by using executable computer program instructions in a general-purpose or special-purpose processor that may be stored on a computer readable storage medium (disk, memory etc) to be executed by such a processor.

As used here ‘module’ refers to a unit or apparatus that excludes certain parts/components that would be added by an end manufacturer or a user to form a usable apparatus 20.

The blocks illustrated in FIG. 6 may represent steps in a method and/or sections of code in a computer program. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1-33. (canceled)

34. An optical proximity sensor system comprising:
a light emitter configured to emit light;
a diffractive optical element positioned in front of the light emitter and configured to direct light emitted by the light emitter towards a target volume in front of the diffractive optical element; and
a light detector configured to detect light reflected from a proximal object at the target volume, and
wherein the optical proximity sensor system is configured to direct light emitted by the light emitter through an apparatus housing comprising at least one aperture and the target volume in front of the diffractive optical element is located in front of the aperture at an exterior of the apparatus housing.

35. An optical proximity sensor system as claimed in claim 34, wherein a cross-sectional area of the emitted light increases as it travels towards the diffractive optical element and a cross-sectional area of the directed light decreases as it is travels away from the diffractive optical element.

36. An optical proximity sensor system as in claim 34, wherein the light emitter emits light which is distributed about a mean emission vector and the diffractive optical element is configured to direct the emitted light such that the directed light is distributed about a mean directed vector, wherein the mean directed vector has an angular deviation from the mean emission vector in a direction towards the light detector.

37. An optical proximity sensor system as claimed in claim 34, wherein the target volume is positioned over a point that is equidistant between the light emitter and the light detector.

38. An optical proximity sensor system as claimed in claim 34, wherein the diffractive optical element seals a cavity in the apparatus housing comprising the light emitter.

39. An optical proximity sensor system as claimed in claim 34, wherein the diffractive optical element has a flat top surface.

40. An optical proximity sensor system as claimed in claim 34, comprising a diffractive optical element positioned in front of the light detector and configured to direct light reflected from a proximal object at the target volume towards the light detector.

41. An optical proximity sensor system as claimed in claim 40, wherein a cross-sectional area of the reflected light decreases as it is travels away from the diffractive optical element positioned in front of the light detector.

42. An optical proximity sensor system as claimed in claim 40, wherein the diffractive optical element positioned in front of the light detector seals a cavity in the apparatus housing comprising the light detector.

43. An optical proximity sensor system as claimed in claim 40, wherein the diffractive optical element positioned in front of the light detector is separate and distinct from the diffractive optical element positioned in front of the light emitter.

44. An optical proximity sensor system as claimed in claim 40, wherein the diffractive optical element positioned in front of the light detector and the diffractive optical element positioned in front of the light emitter are parts of a common diffractive optical element.

45. An optical proximity sensor system as claimed in claim 34, wherein the diffractive optical element is configured to enable cross-talk between the light emitter and light detector.

46. An optical proximity sensor system as claimed in claim 34, further comprising a controller configured, when the light emitter is off, to set at least one threshold from an ambient value detected at the light detector and configured, when the light emitter is on, to compare a value detected at the light detector with the threshold.

47. An optical proximity sensor system as claimed in claim 46, wherein the controller is configured to determine that the optical proximity sensor is not working properly when the comparison determines that the value detected is less than a first threshold.

48. An optical proximity sensor system as claimed in claim 46, wherein the controller is configured to determine that the optical proximity sensor is suffering from too much cross-talk when the comparison determines that the value detected is greater than a second threshold.

49. An optical proximity sensor system as claimed in claim 34, further comprising a fixing configured to enable at least one of the replacement of diffractive optical elements and the positioning of diffractive optical elements at a desired distance from the light emitter.

50. An optical proximity sensor system as claimed in claim 34, further comprising an optical isolator that optically isolates the light detector from the light emitter.

51. An optical proximity sensor system as claimed in claim 34, further comprising an additional light detector.

52. An optical proximity sensor system according to claim 34, wherein the absence of an optical masking material on an interior surface of the apparatus housing defines the aperture.

53. An optical proximity sensor system according to claim 34, wherein the aperture is an optical aperture.
